(19) United States
(12) Patent Application Publication
(10) Pub. No.: US 2025/0105897 A1
(43) Pub. Date: Mar. 27, 2025

(54) COORDINATED CHANNEL STATE INFORMATION PARAMETER DETERMINATION

(71) Applicant: QUALCOMM Incorporated, San Deigo, CA (US)

(72) Inventors: Ahmed ELSHAFIE, San Diego, CA (US); Kianoush HOSSEINI, San Diego, CA (US); Yu ZHANG, San Diego, CA (US); Wanshi CHEN, San Diego, CA (US); Peter GAAL, San Diego, CA (US)

(21) Appl. No.: 18/728,996

(22) PCT Filed: Mar. 31, 2022
(86) PCT No.: PCT/CN2022/084280

§ 371 Date: Jul. 15, 2024

(51) Int. Cl. H04B 7/06; H04B 7/0456; H04W 72/25

(52) U.S. Cl. CPC H04B 7/0626; H04B 7/0456; H04W 72/25

(57) ABSTRACT

Various aspects of the present disclosure generally relate to wireless communication. In some aspects, a first network node may transmit a first sidelink reference signal (SL-RS) to a second network node. The first network node may receive, from the second network node, a second SL-RS and channel state information (CSI) that is associated with the first (SL-RS). The first network node may determine a (CSI)-related parameter based on the second (SL-RS) and the (CSI). The first network node may transmit, to the second network node, the (CSI)-related parameter or a communication based on the (CSI)-related parameter. Numerous other aspects are described.

### FIELD OF THE DISCLOSURE

Aspects of the present disclosure generally relate to wireless communication and to techniques and apparatuses for coordinated determination of parameters related to channel state information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first network node. The method may include transmitting a first sidelink reference signal (SL-RS) to a second network node. The method may include receiving, from the second network node, a second SL-RS and channel state information (CSI) that is associated with the first SL-RS. The method may include determining a CSI-related parameter based on the second SL-RS and the CSI. The method may include transmitting, to the second network node, the CSI-related parameter or a communication based on the CSI-related parameter.

Some aspects described herein relate to a method of wireless communication performed by a second network node. The method may include receiving a first SL-RS from a first network node. The method may include generating CSI based on the first SL-RS. The method may include transmitting, to the first network node, the CSI and a second SL-RS. The method may include receiving, from the first network node, a CSI-related parameter associated with the CSI or a communication based on the CSI-related parameter.

Some aspects described herein relate to a first network node for wireless communication. The first network node may include a memory and one or more processors coupled to the memory. The one or more processors may be configured to transmit a first SL-RS to a second network node. The one or more processors may be configured to receive, from the second network node, a second SL-RS and CSI that is associated with the first SL-RS. The one or more processors may be configured to determine a CSI-related parameter based on the second SL-RS and the CSI. The one or more processors may be configured to transmit, to the second network node, the CSI-related parameter or a communication based on the CSI-related parameter.

Some aspects described herein relate to a second network node for wireless communication. The second network node may include a memory and one or more processors coupled to the memory. The one or more processors may be configured to receive a first SL-RS from a first network node. The one or more processors may be configured to generate CSI based on the first SL-RS. The one or more processors may be configured to transmit, to the first network node, the CSI and a second SL-RS. The one or more processors may be configured to receive, from the first network node, a CSI-related parameter associated with the CSI or a communication based on the CSI-related parameter.

Some aspects described herein relate to a non-transitory computer-readable medium that stores a set of instructions for wireless communication by a first network node. The set of instructions, when executed by one or more processors of the first network node, may cause the first network node to transmit a first SL-RS to a second network node. The set of instructions, when executed by one or more processors of the first network node, may cause the first network node to receive, from the second network node, a second SL-RS and CSI that is associated with the first SL-RS. The set of instructions, when executed by one or more processors of the first network node, may cause the first network node to determine a CSI-related parameter based on the second SL-RS and the CSI. The set of instructions, when executed by one or more processors of the first network node, may cause the first network node to transmit, to the second network node, the CSI-related parameter or a communication based on the CSI-related parameter.

Some aspects described herein relate to a non-transitory computer-readable medium that stores a set of instructions for wireless communication by a second network node. The set of instructions, when executed by one or more processors of the second network node, may cause the second network node to receive a first SL-RS from a first network node. The set of instructions, when executed by one or more processors of the second network node, may cause the second network node to generate CSI based on the first SL-RS. The set of instructions, when executed by one or more processors of the second network node, may cause the second network node to transmit, to the first network node, the CSI and a second SL-RS. The set of instructions, when executed by one or more processors of the second network node, may cause the second network node to receive, from the first network node, a CSI-related parameter associated with the CSI or a communication based on the CSI-related parameter.

Some aspects described herein relate to an apparatus for wireless communication. The apparatus may include means for transmitting a first SL-RS to another apparatus. The apparatus may include means for receiving, from the other apparatus, a second SL-RS and CSI that is associated with the first SL-RS. The apparatus may include means for determining a CSI-related parameter based on the second SL-RS and the CSI. The apparatus may include means for transmitting, to the other apparatus, the CSI-related parameter or a communication based on the CSI-related parameter.

Some aspects described herein relate to an apparatus for wireless communication. The apparatus may include means for receiving a first SL-RS from another apparatus. The apparatus may include means for generating CSI based on the first SL-RS. The apparatus may include means for transmitting, to the other apparatus, the CSI and a second SL-RS. The apparatus may include means for receiving, from the other apparatus, a CSI-related parameter associated with the CSI or a communication based on the CSI-related parameter.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of sidelink communications, in accordance with the present disclosure.

FIG. 5 is a diagram illustrating an example of coordinated channel state information parameter determination, in accordance with the present disclosure.

FIG. 6 is a diagram illustrating an example process performed, for example, by a first network node, in accordance with the present disclosure.

FIG. 7 is a diagram illustrating an example process performed, for example, by a second network node, in accordance with the present disclosure.

FIGS. 8-9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

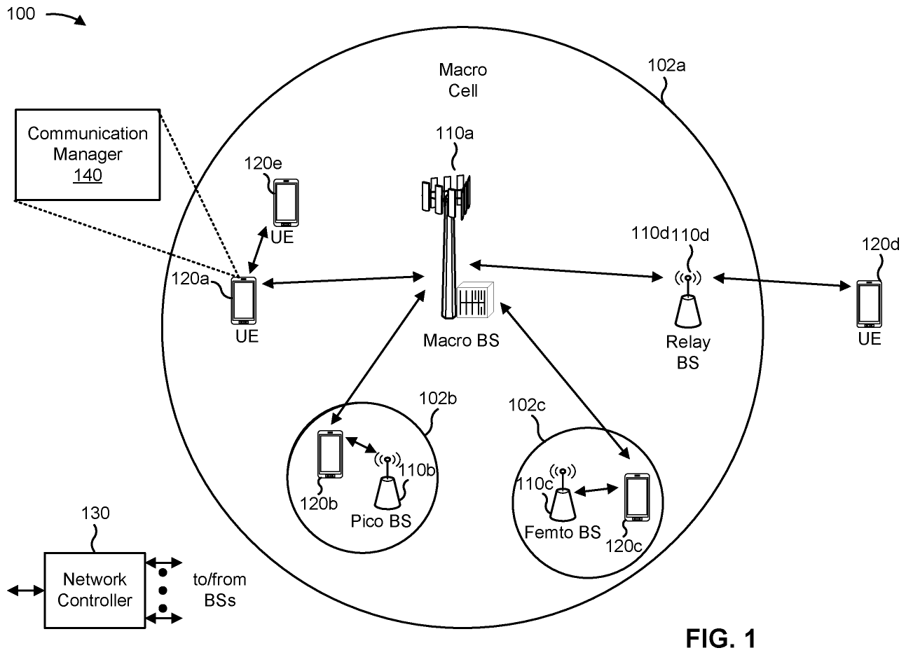

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network nodes. A base station 110 is a network node that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

The wireless network 100 may include one or more relay stations. A relay station is a network node that can receive a transmission of data from an upstream network node (e.g., a base station 110 or a UE 120) and send a transmission of the data to a downstream network node (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more network nodes (e.g., shown as UE 120a and UE 120e) may communicate directly using one or more sidelink channels (e.g., without using a base station 110 as an intermediary to communicate with one another). For example, the network nodes may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a network node (e.g., a UE 120) may perform scheduling operations, resource selection operations, and/or other operations described elsewhere herein as being performed by another network node (e.g., a base station 110).

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FRI is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first network node (e.g., UE 120) may include a communication manager 140. As described in more detail elsewhere herein, the communication manager 140 may transmit a first sidelink reference signal (SL-RS) to a second network node and receive, from the second network node, a second SL-RS and channel state information (CSI) that is associated with the first SL-RS. The communication manager 140 may determine a CSI-related parameter based on the second SL-RS and the CSI and transmit, to the second network node, the CSI-related parameter or a communication based on the CSI-related parameter. Additionally, or alternatively, the communication manager 140 may perform one or more other operations described herein.

In some aspects, a second network node (e.g., UE 120) may include a communication manager 140. As described in more detail elsewhere herein, the communication manager 140 may receive a first SL-RS from a first network node and generate CSI based on the first SL-RS. The communication manager 140 may transmit, to the first network node, the CSI and a second SL-RS and receive, from the first network node, a CSI-related parameter associated with the CSI or a communication based on the CSI-related parameter. Additionally, or alternatively, the communication manager 140 may perform one or more other operations described herein.

As indicated above, FIG. 1 is provided as an example. Other examples may differ from what is described with regard to FIG. 1.

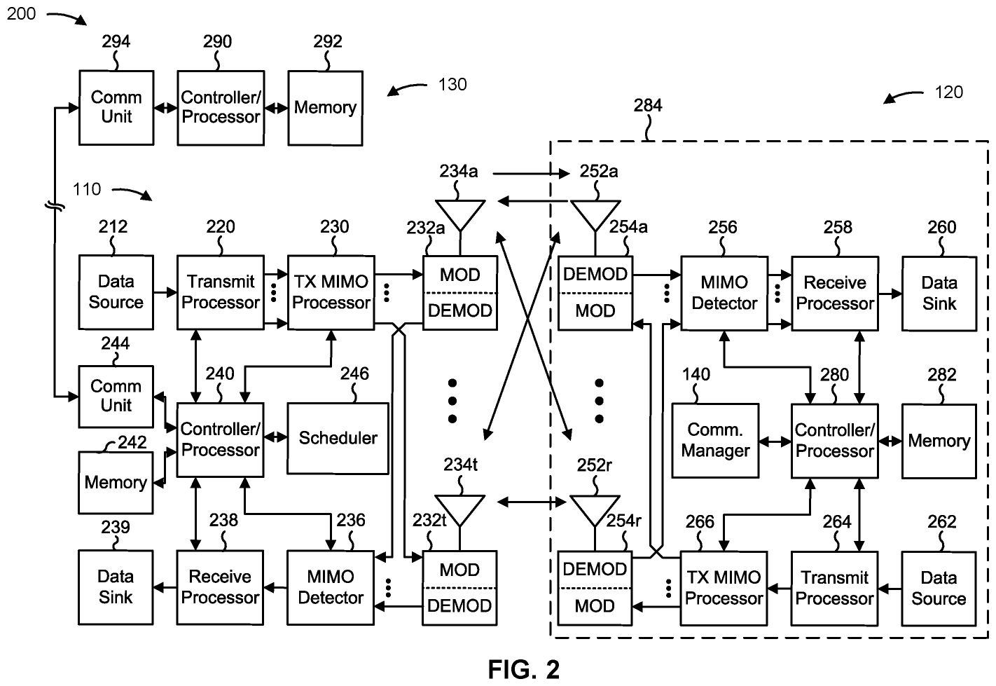

FIG. 2 is a diagram illustrating an example 200 of a network node (e.g., a base station 110) in communication with another network node (e.g., a UE 120) in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based on one or more channel quality indicators (CQIs) received from that UE 120. The base station 110 may process (e.g., encode and modulate) the data for the UE 120 based on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

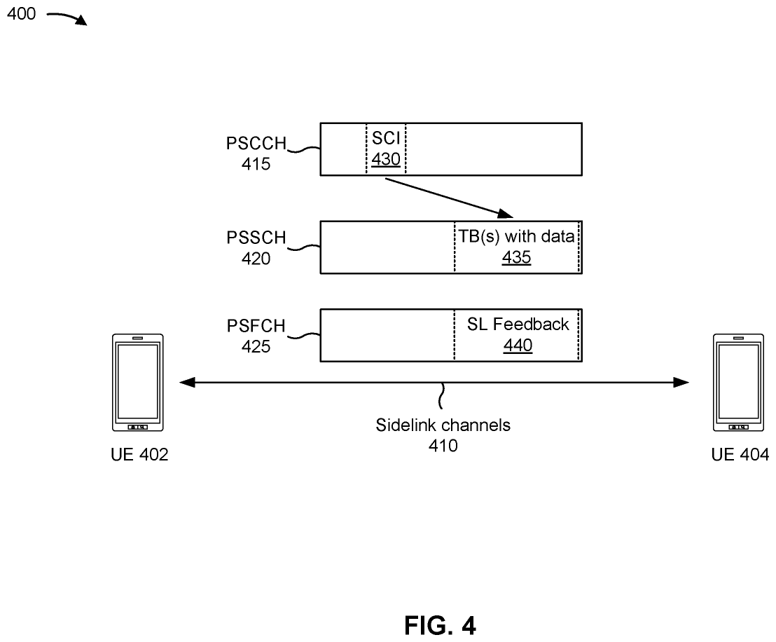

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-8).

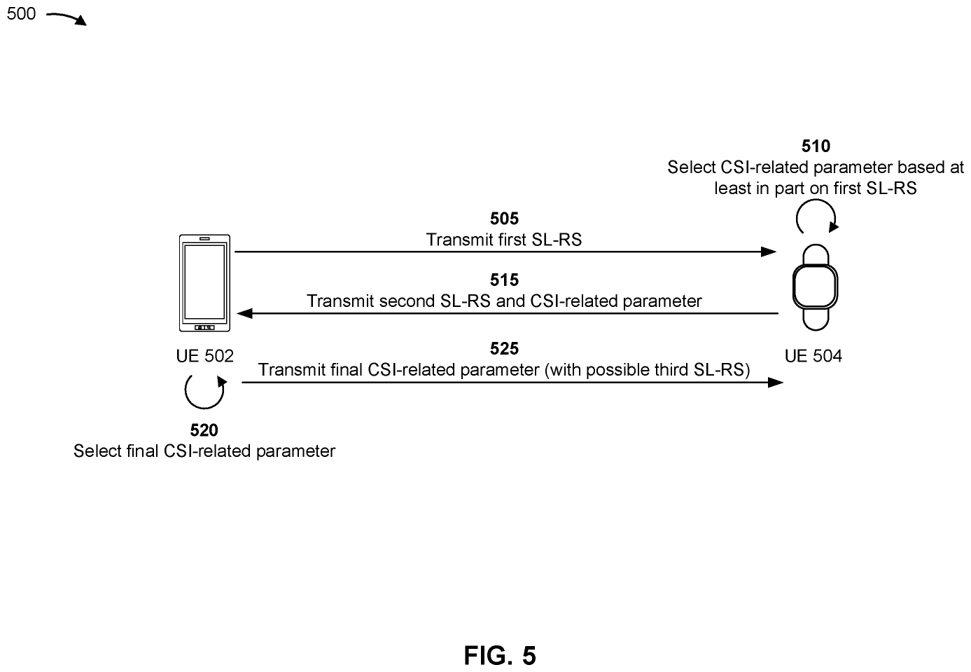

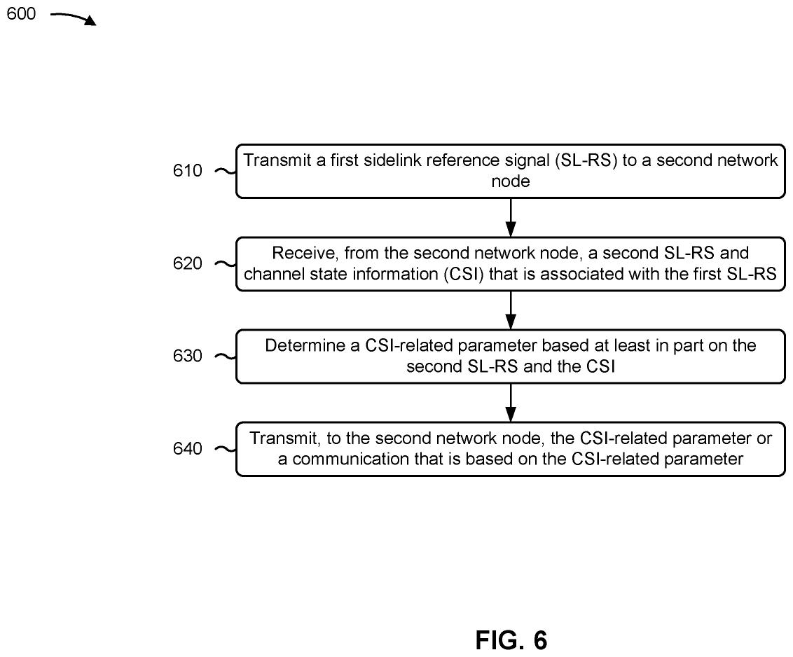

A controller/processor of a network node (e.g., the controller/processor 240 of the base station 110, the controller/processor 280 of the UE 120), and/or any other component(s) of FIG. 2 may perform one or more techniques associated with coordinated determination of CSI-related parameters for sidelink, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, a first network node (e.g., a UE 120) includes means for transmitting a first SL-RS to a second network node; means for receiving, from the second network node, a second SL-RS and CSI that is associated with the first SL-RS; means for determining a CSI-related parameter based on the second SL-RS and the CSI; and/or means for transmitting, to the second network node, the CSI-related parameter or a communication based on the CSI-related parameter. In some aspects, the means for the first network node to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second network node (e.g., a UE 120) includes means for receiving a first SL-RS from a first network node; means for generating CSI based on the first SL-RS; means for transmitting, to the first network node, the CSI and a second SL-RS; and/or means for receiving, from the first network node, a CSI-related parameter associated with the CSI or a communication based on the CSI-related parameter. In some aspects, the means for the second network node to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

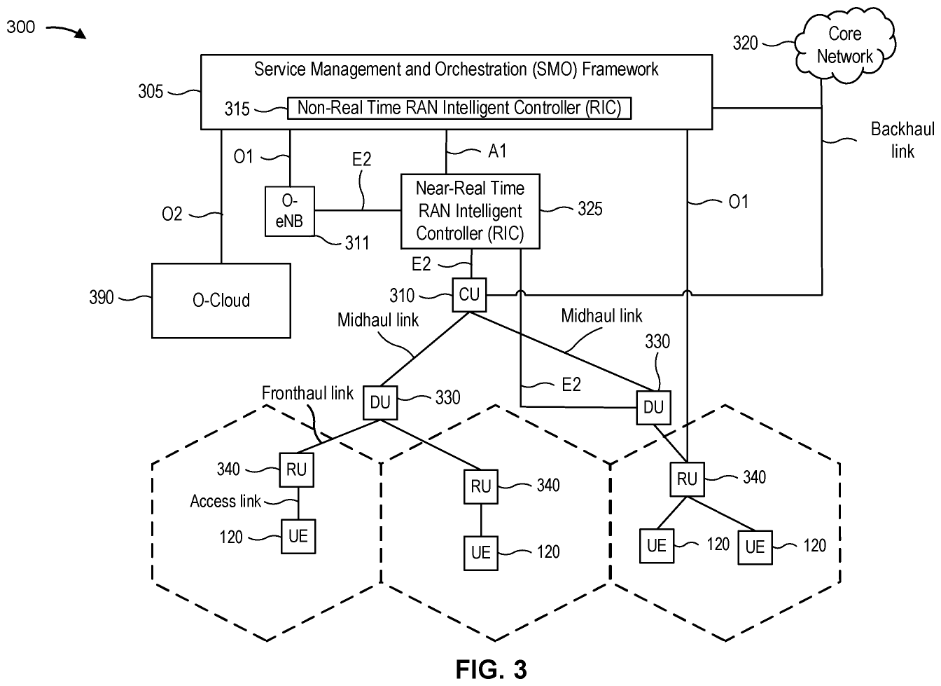

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUS (O-DUs”) and “O-RAN RUs (O-RUs)”, respectively. A network node may include a CU, a DU, an RU, or any combination of CUs, DUs, and RUs. A network node may include a disaggregated base station or one or more components of the disaggregated base station, such as a CU, a DU, an RU, or any combination of CUs, DUs, and RUs. A network node may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325 The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating an example 400 of sidelink communications, in accordance with the present disclosure.

As shown in FIG. 4, a first UE 402 (e.g., UE 120e) may communicate with a second UE 404 (e.g., UE 120a) (and one or more other UEs) via one or more sidelink channels 410. UE 402 and UE 404 may communicate using the one or more sidelink channels 410 for P2P communications, D2D communications, V2X communications (e.g., which may include V2V communications, V2I communications, and/or V2P communications) and/or mesh networking. In some aspects, UE 402 and UE 404 may correspond to one or more other UEs. In some aspects, the one or more sidelink channels 410 may use a PC5 interface and/or may operate in a high frequency band (e.g., the 5.9 gigahertz (GHz) band). Additionally, or alternatively, UE 402 and UE 404 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a base station (e.g., base station 110) via an access link or an access channel. The PSSCH 420 may be used to communicate data, similar to a physical downlink shared channel (PDSCH) and/or a physical uplink shared channel (PUSCH) used for cellular communications with a base station via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, UE 404 may operate using a transmission mode where resource selection and/or scheduling is performed by UE 402 (e.g., rather than a base station). In some aspects, UE 402 and/or UE 404 may perform resource selection and/or scheduling by sensing channel availability for transmissions. For example, UE 404 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, may measure an RSRQ parameter (e.g., a PSSCH-RSRQ parameter) associated with various sidelink channels, and/or may determine a signal-to-interference ratio (SIR) associated with another UE on a sidelink channel. UE 404 may select a channel for transmission of a sidelink communication based on the measurement(s).

Additionally, or alternatively, UE 404 may perform resource selection and/or scheduling using SCI 430 received in the PSCCH 415, which may indicate occupied resources and/or channel parameters. Additionally, or alternatively, UE 404 may perform resource selection and/or scheduling by determining a channel busy rate (CBR) associated with various sidelink channels, which may be used for rate control (e.g., by indicating a maximum number of resource blocks that UE 404 can use for a particular set of subframes).

In the transmission mode where resource selection and/or scheduling is performed by UE 402, UE 402 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, UE 402 may generate a sidelink grant that indicates one or more parameters for semi-persistent scheduling (SPS), such as a periodicity of a sidelink transmission. Additionally, or alternatively, UE 402 may generate a sidelink grant for event-driven scheduling, such as for an on-demand sidelink message. UE 402 and UE 404 may operate in sidelink resource allocation Mode 2, in which UE 402 and UE 404 schedule or reserve their own sidelink resources without the assistance or direction of a base station (Mode 1). In some aspects, UE 402 may indicate available sidelink resources to UE 404, and UE 404 may select a sidelink resource for transmission from these available sidelink resources. UE 404 may also sense one or more of the sidelink channels 410 to determine which sidelink resources are available. UE 404 may select a sidelink resource for transmission from the sidelink resources that UE 402 indicates as available and/or from the sidelink resources that UE 404 senses are available. As described in various aspects herein, UE 402 may schedule one or more preferred sidelink resources on behalf of UE 404.

UE 402 may transmit an SL-RS, such as a CSI reference signal (CSI-RS), on a sidelink channel to UE 404. UE 404 may measure the SL-RS (e.g., channel estimation) and select a parameter based on the measurement. The parameter may be related to CSI and may include, for example, a precoding matrix indicator (PMI), transmit PMI (TPMI), and/or a rank indicator (RI) for the SL-RS. UE 404 may transmit the parameter to UE 402, and UE 402 may use the parameter for sidelink resource reservations and/or transmitting a communication to UE 402 on the sidelink channel. However, in some scenarios, UE 404 may be a lower power device or a less complex device, such as a wearable (e.g., smartwatch, sensor) or a reduced capacity (RedCap) device. UE 402 may not be able to fully perform a channel state feedback (CSF) procedure or a fast CSF procedure (e.g., quicker procedure, less estimation) to estimate an accurate parameter for the sidelink channel. For example, UE 402 may not be able to fully search all available PMIs for the sidelink channel, in order to fully estimate the sidelink channel. UE 402 may also not be able to quickly search a subset of the PMIs. Without accurate and timely CSF, UE 402 and UE 404 may experience degraded communications that waste processing resources and signaling resources.

As indicated above, FIG. 4 is provided as an example. Other examples may differ from what is described with regard to FIG. 4.

FIG. 5 is a diagram illustrating an example 500 of coordinated CSI parameter determination, in accordance with the present disclosure. Example 500 shows a UE 502 (e.g., UE 402) and a UE 504 (e.g., UE 404) that may communicate (e.g., transmit an uplink transmission and/or receive a downlink transmission) with each other on a sidelink channel. In some aspects, UE 502 may be a receiving UE (for receiving communications), and UE 504 may be a transmitting UE (for transmitting the communications). In some aspects, UE 502 may be a more capable device than UE 504. For example, UE 502 may be a smart phone (or a controlling UE, a primary UE, or programmable logic controller (PLC)), and UE 504 may be a lower power/complexity device, such as a smart watch or an IoT device.

According to various aspects described herein, UE 502 and UE 504 may cooperate to determine (e.g., identify, select) one or more parameters for the sidelink channel that are related to CSI, such as a PMI, a TPMI, and/or a RI. UE 502 may assist UE 504 in obtaining a more accurate CSI-related parameter that UE 504 may not be able to obtain on its own.

As shown by reference number 505, UE 502 may transmit a first SL-RS on the sidelink channel, and UE 504 may use the first SL-RS to estimate the sidelink channel and select a CSI-related parameter (e.g., PMI, RI, CQI), as shown by reference number 510. UE 504 may use a low processing CSF procedure due to its more limited capabilities. UE 504 may transmit the CSI-related parameter (e.g., PMI, RI, CQI) in SCI-2 while transmitting a second SL-RS, as shown by reference number 515. The second SL-RS may have a lower power than the first SL-RS, given that UE 504 is a lower power device.

In some aspects, UE 504 may not be able to perform a fast CSF procedure (a and thus is not configured for a fast CSF procedure), and UE 502 may transmit a set of PMIs (and corresponding RIs) for which UE 504 may more reasonably search. The set of PMIs (and RIs) may be a subset of available PMIs and RIs from which UE 504 may select a PMI and RI. UE 502 may transmit the set of PMIs and RIs in SCI-2 while transmitting the first SL-RS. UE 504 may use the set of PMIs and RIs not only for the coordinated CSI but for other PSSCH precoding or transmissions.

As shown by reference number 520, UE 502 may estimate the channel with the second SL-RS and select a final CSI-related parameter (e.g., final PMI, final RI, final CQI) based on the CSI-related parameter (e.g., PMI, RI, CQI) reported by UE 504 and the channel estimation of the second SL-RS. UE 502 may select the PMI (and corresponding RI) reported by UE 504 after searching for a PMI spatially correlated with the PMI reported by UE 504. UE 504 may transmit multiple candidate PMIs and RIs and UE 502 may select from among the multiple candidate PMIs and RIs. UE 502 may also select a new PMI that is not among PMIs reported by UE 504. The final PMI (and final RI) selected by UE 502 may represent a final decision of the coordinated determination of the PMI (and RI) between UE 502 and UE 504. As shown by reference number 525, UE 502 may transmit the final CSI-related parameter (e.g., final PMI or PMIs, final RI or RIs) to UE 504. UE 502 may transmit the final CSI-related parameter on SCI-2 of the PSSCH, via the PSFCH, or via a medium access control control element (MAC CE). UE 504 may then transmit a communication based on the final CSI-related parameter received from UE 502. In some aspects, UE 502 may transmit a communication that uses or is based on the final CSI-related parameter.

By coordinating or jointly performing CSI estimation, UE 502 may use its greater capability for CSF to help UE 504 obtain a more accurate CSI-related parameter. Furthermore, UE 502 may avoid transmitting an SL-RS in unwanted directions, which may cause interference for other UEs in multiple locations.

In some aspects, UE 504 may seek help with CSF computation and may transmit a request for coordinated CSI to UE 502. Alternatively, UE 502 may proceed with coordinated CSI without a request from UE 504, and UE 502 may inform UE 504 that coordinated CSI is to begin. UE 502 may configure UE 504 (via a PC5 radio resources control (RRC) message or a MAC CE) as to when coordinated CSI is to begin after the request.

Unlike in legacy CSF procedures where a response to an SL-RS request is regularly a CQI/RI report in a MAC CE, UE 504 may refrain from transmitting the CQI/RI report in a MAC CE as normally expected. Rather, UE 502 or UE 504 may indicate in SCI-2 associated with the SL-RS resources whether a coordinated CSF procedure or a regular CSF procedure is to be performed. UE 502 or UE 504 may also indicate (in SCI-2 along with the SL-RS) whether the report is to be a PMI/RI report, a CQI/RI report, or a PMI+CQI/RI report. UE 502 or UE 504 may also indicate whether there will be no report. Alternatively, rather than dynamically indicating the report type, UE 502 or UE 504 may determine the type of report or if there is no report based on a semi-static configuration.

An SL-RS report configuration may have multiple SL-RS resources. There may be multiple SL-RS configurations. In some aspects, one or more of the multiple SL-RS configurations may be activated per resource pool. In some aspects, a single SL-RS configuration may be activated via SCI.

In some aspects, UE 502 may operate in one of two or more modes of operation for reporting a CSI-related parameter. In a first mode, UE 502 (or whichever UE is measuring a final PMI and RI pair) may select a set of PMI and RI pairs to be reported by UE 504. In a second mode, UE 502 may try multiple candidate PMI and RI pairs (as well as new PMI and RI pairs) and then transmit the final PMI and RI pair based on trying the multiple candidate PMI and RI pairs. The mode may be set by UE 502 or UE 504 via a PC5 RRC message, a MAC CE, or SCI-2. If the second mode is selected, UE 502 may indicate to UE 504 (e.g., via 1 bit on the PSFCH or a MAC CE) whether UE 502 is to select a final PMI and RI pair from multiple candidate PMI and RI pairs provided by UE 504 or to select a new PMI and RI pair. UE 502 may transmit a second PSFCH or MAC CE with multiple bits (based on a report size) indicating the final PMI and RI pair. In some aspects, only a final PMI is selected.

For example, if there are N candidate PMI and RI pairs, then after UE 504 performs a CSF procedure to obtain a CSI-related parameter, UE 504 may transmit K candidate PMI and RI pairs as the best pairs. UE 502 may try the K candidate PMI and RI pairs on an estimated channel to determine which PMI and RI pair is best. UE 502 may try other PMI and RI pairs that are part of the N PMI and RI pairs but not part of the K PMI and RI pairs. Trying a candidate PMI and RI pair may include computing the best beam or beams based on the channel estimation for an SL-RS. For example, if the channel, represented by Hᵢ, is estimated for 1 RE with Rank 1, a covariance matrix Cᵢ of the channel Hᵢ is Hᵢ*H′ᵢ (Hermitian matrix for Hᵢ) for an ith RE. UE 504 may compute the best beam or set of beams for the RE using an energy matrix EM(k)=PMIₖ*Cᵢ*PMIₖ′ (Hermitian), where UE 504 tries all of k where k=1 through N. UE 504 may report, as part of the PMI and RI pair, the PMIₖ for the k that is the best (highest energy).

UE 502 may select the final PMI (and final RI) based on the reported PMI and RI pair. In some aspects, UE 502 may transmit a third SL-RS when transmitting the final PMI (and final RI) to UE 504. UE 504 may select a PMI and RI based on the final PMI, the final RI, and a measurement of the third SL-RS, as part of a further refinement of the PMI and RI that UE 504 is to use. By coordinating the determination of a CSI-related parameter, the CSI-related parameter may be more accurate. Accurate CSI-related parameters may provide for better communications that waste less processing resources and signaling resources.

As indicated above, FIG. 5 is provided as an example. Other examples may differ from what is described with regard to FIG. 5.

FIG. 6 is a diagram illustrating an example process 600 performed, for example, by a first network node, in accordance with the present disclosure. Example process 600 is an example where the first network node (e.g., UE 120, UE 502) performs operations associated with coordinated CSI-related parameter determination.

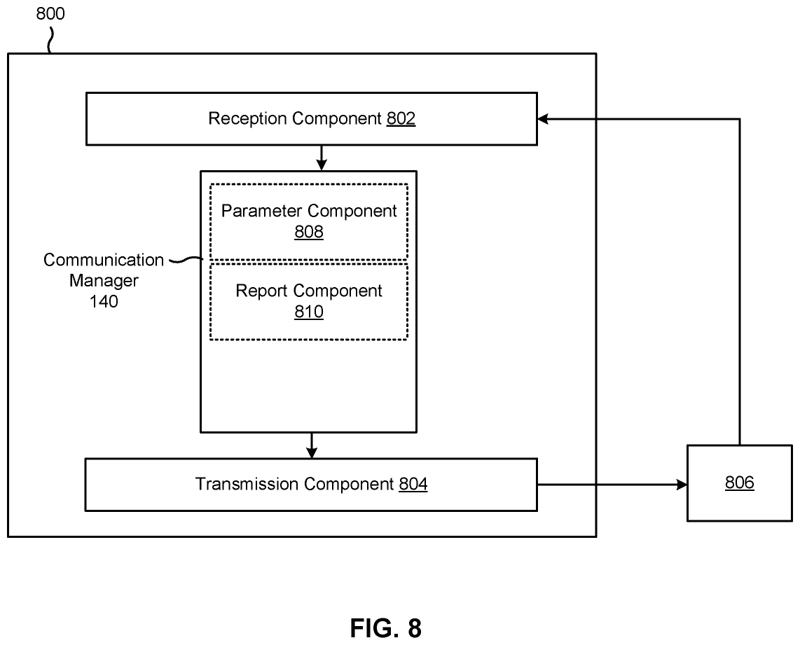

As shown in FIG. 6, in some aspects, process 600 may include transmitting a first SL-RS to a second network node (block 610). For example, the first network node (e.g., using communication manager 140 and/or transmission component 804 depicted in FIG. 8) may transmit a first SL-RS to a second network node, as described above.

As further shown in FIG. 6, in some aspects, process 600 may include receiving, from the second network node, a second SL-RS and CSI that is associated with the first SL-RS (block 620). For example, the first network node (e.g., using communication manager 140 and/or reception component 802 depicted in FIG. 8) may receive, from the second network node, a second SL-RS and CSI that is associated with the first SL-RS, as described above.

As further shown in FIG. 6, in some aspects, process 600 may include determining a CSI-related parameter based on the second SL-RS and the CSI (block 630). For example, the first network node (e.g., using communication manager 140 and/or parameter component 808 depicted in FIG. 8) may select a CSI-related parameter based on the second SL-RS and the CSI, as described above. In some aspects, determining the CSI-related parameter based on the second SL-RS and the CSI may include identifying or selecting the CSI-related parameter based on the second SL-RS and the CSI.

As further shown in FIG. 6, in some aspects, process 600 may include transmitting, to the second network node, the CSI-related parameter or a communication based on the CSI-related parameter (block 640). For example, the first network node (e.g., using communication manager 140 and/or transmission component 804 depicted in FIG. 8) may transmit, to the second network node, the CSI-related parameter or a communication based on the CSI-related parameter, as described above.

Process 600 may include additional aspects, such as any single aspect or any combination of aspects described below and/or in connection with one or more other processes described elsewhere herein.

In a first aspect, transmitting the CSI-related parameter includes transmitting the CSI-related parameter with a third SL-RS.

In a second aspect, alone or in combination with the first aspect, the CSI includes one or more PMIs, and determining the CSI-related parameter includes determining a PMI from the one or more PMIs. The CSI may also include one or more RIs that correspond to the one or more PMIs, and the determining may include also determining an RI from the one or more RIs.

In a third aspect, alone or in combination with one or more of the first and second aspects, determining the PMI includes searching for a PMI that is spatially correlated with the one or more PMIs.

In a fourth aspect, alone or in combination with one or more of the first through third aspects, the first network node does not have a capability for or is incapable of performing a fast CSF procedure.

In a fifth aspect, alone or in combination with one or more of the first through fourth aspects, a transmit power of the first SL-RS is higher than a transmit power of the second SL-RS.

In a sixth aspect, alone or in combination with one or more of the first through fifth aspects, a transmit power of the first SL-RS is lower than a transmit power of the second SL-RS.

In a seventh aspect, alone or in combination with one or more of the first through sixth aspects, transmitting the first SL-RS and transmitting the CSI-related parameter includes transmitting the first SL-RS and transmitting the CSI-related parameter in connection with receiving a request for coordinated CSI.

In an eighth aspect, alone or in combination with one or more of the first through seventh aspects, process 600 includes transmitting, via SCI-2, an indication of whether coordinated CSI is to be performed.

In a ninth aspect, alone or in combination with one or more of the first through eighth aspects, the indication indicates whether the CSI is to include one or more of a PMI and RI report, a CQI and RI report, or a PMI, CQI, and RI report. The CSI may include one or more subreports of the PMI and RI report, the CQI and RI report, or the PMI, CQI, and RI report. A subreport may include a portion of the full report. For example, the CSI may include a first PMI and RI subreport, a second PMI and RI subreport, a third PMI and RI subreport, or a combination thereof,

In a tenth aspect, alone or in combination with one or more of the first through ninth aspects, process 600 includes determining, based on stored configuration information, whether the CSI is to include one or more of a PMI and RI report, a CQI and RI report, or a PMI, CQI, and RI report.

In an eleventh aspect, alone or in combination with one or more of the first through tenth aspects, receiving the CSI includes receiving the CSI in SCI-2 with SL-RS resource information.

In a twelfth aspect, alone or in combination with one or more of the first through eleventh aspects, the CSI includes one or more PMI and RI pairs, and determining the CSI-related parameter includes determining a PMI and RI pair only from among the one or more PMI and RI pairs, according to a first mode, or determining a PMI and RI pair that is not restricted to the one or more PMI and RI pairs, according to a second mode.

In a thirteenth aspect, alone or in combination with one or more of the first through twelfth aspects, process 600 includes transmitting, prior to transmitting the selected PMI and RI pair as the CSI-related parameter, an indication of whether the first network node is to operate in the first mode or the second mode.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

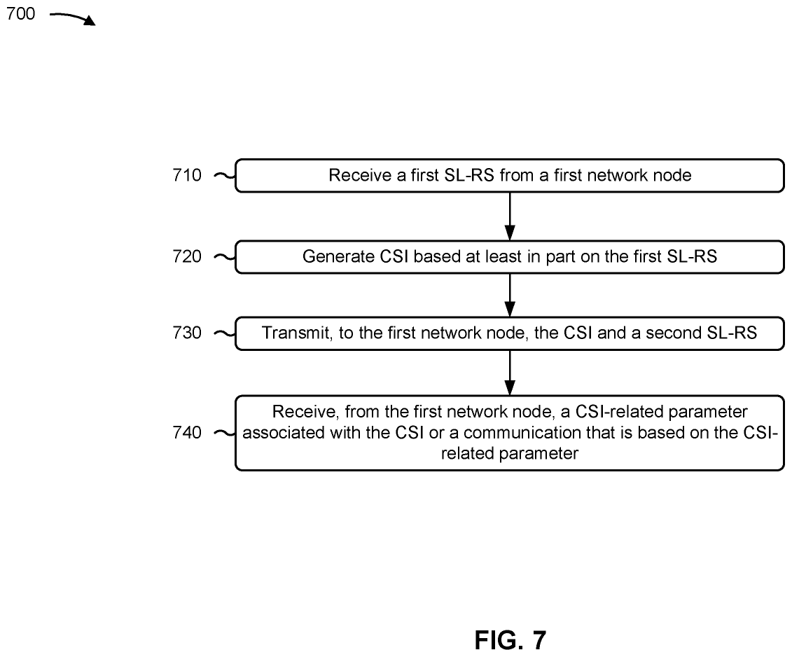

FIG. 7 is a diagram illustrating an example process 700 performed, for example, by a second network node, in accordance with the present disclosure. Example process 700 is an example where the second network node (e.g., UE 120, UE 504) performs operations associated with coordinated CSI-related parameter determination.

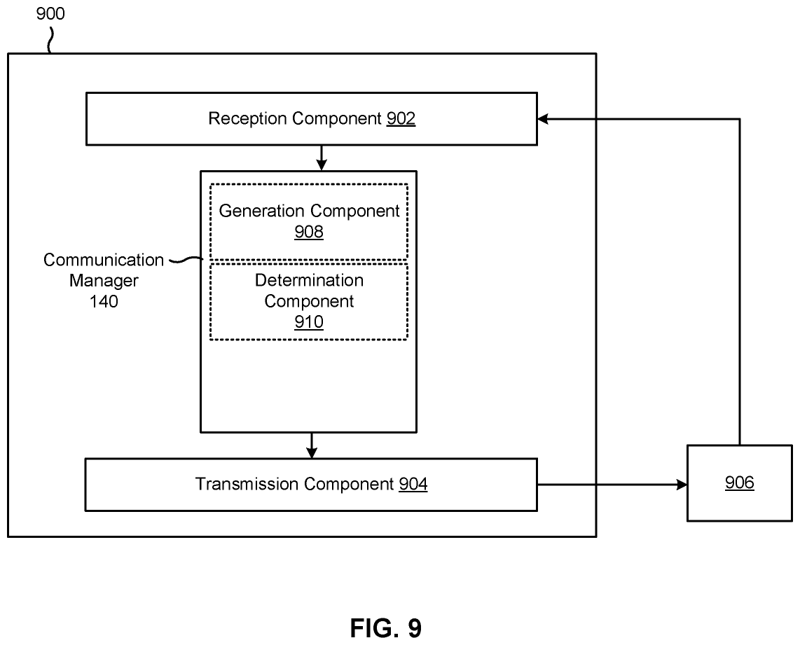

As shown in FIG. 7, in some aspects, process 700 may include receiving a first SL-RS from a first network node (block 710). For example, the second network node (e.g., using communication manager 140 and/or reception component 902 depicted in FIG. 9) may receive a first SL-RS from a first network node, as described above.

As further shown in FIG. 7, in some aspects, process 700 may include generating CSI based on the first SL-RS (block 720). For example, the second network node (e.g., using communication manager 140 and/or generation component 908 depicted in FIG. 9) may generate CSI based on the first SL-RS, as described above.

As further shown in FIG. 7, in some aspects, process 700 may include transmitting, to the first network node, the CSI and a second SL-RS (block 730). For example, the second network node (e.g., using communication manager 140 and/or transmission component 904 depicted in FIG. 9) may transmit, to the first network node, the CSI and a second SL-RS, as described above.

As further shown in FIG. 7, in some aspects, process 700 may include receiving, from the first network node, a CSI-related parameter associated with the CSI or a communication based on the CSI-related parameter (block 740). For example, the second network node (e.g., using communication manager 140 and/or reception component 902 depicted in FIG. 9) may receive, from the first network node, a CSI-related parameter associated with the CSI or a communication based on the CSI-related parameter, as described above.

Process 700 may include additional aspects, such as any single aspect or any combination of aspects described below and/or in connection with one or more other processes described elsewhere herein.

In a first aspect, receiving the CSI-related parameter includes receiving the CSI-related parameter with a third SL-RS, and process 700 includes verifying the CSI-related parameter based on the third SL-RS and transmitting a message or another CSI-related parameter to the first network node based on a result of the verifying.

In a second aspect, alone or in combination with the first aspect, the CSI includes one or more PMIs, and the CSI-related parameter is one of the one or more PMIs. The CSI may also include one or more RIs that correspond to the one or more PMIs, and the determining may include also determining an RI from the one or more RIs.

In a third aspect, alone or in combination with one or more of the first and second aspects, the second network node does not have a capability for or is incapable of performing a fast CSF procedure.

In a fourth aspect, alone or in combination with one or more of the first through third aspects, a transmit power of the first SL-RS is higher than a transmit power of the second SL-RS.

In a fifth aspect, alone or in combination with one or more of the first through fourth aspects, a transmit power of the first SL-RS is lower than a transmit power of the second SL-RS.

In a sixth aspect, alone or in combination with one or more of the first through fifth aspects, process 700 includes transmitting a request for coordinated CSI.

In a seventh aspect, alone or in combination with one or more of the first through sixth aspects, process 700 includes receiving, via SCI-2, an indication of whether coordinated CSI is to be performed.

In an eighth aspect, alone or in combination with one or more of the first through seventh aspects, the indication indicates whether the CSI is to include one or more of a PMI and RI report, a CQI and RI report, or a PMI, CQI, and RI report. The CSI may include one or more subreports of the PMI and RI report, the CQI and RI report, or the PMI, CQI, and RI report. A subreport may include a portion of the full report. For example, the CSI may include a first PMI and RI subreport, a second PMI and RI subreport, a third PMI and RI subreport, or a combination thereof,

In a ninth aspect, alone or in combination with one or more of the first through eighth aspects, process 700 includes determining, based on stored configuration information, whether the CSI is to include one or more of a PMI and RI report, a CQI and RI report, or a PMI, CQI, and RI report.

In a tenth aspect, alone or in combination with one or more of the first through ninth aspects, transmitting the CSI includes transmitting the CSI in SCI-2 with SL-RS resource information.

In an eleventh aspect, alone or in combination with one or more of the first through tenth aspects, the CSI includes one or more PMI and RI pairs, and process 700 includes transmitting, prior to transmitting the CSI, an indication of whether the first network node is restricted to determining a PMI and RI pair only from among the one or more PMI and RI pairs.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a first network node (e.g., UE 120, UE 502), or a first network node may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include a parameter component 808 and/or a report component 810, among other examples.

In some aspects, the apparatus 800 may be configured to perform one or more operations described herein in connection with FIGS. 1-5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the first network node described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the first network node described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the first network node described in connection with FIG. 2. In some aspects, the transmission component 804 may be co-located with the reception component 802 in a transceiver.

The transmission component 804 may transmit a first SL-RS to a second network node. The reception component 802 may receive, from the second network node, a second SL-RS and CSI that is associated with the first SL-RS. The parameter component 808 may select a CSI-related parameter based on the second SL-RS and the CSI. The transmission component 804 may transmit, to the second network node, the CSI-related parameter or a communication based on the CSI-related parameter. The transmission component 804 may transmit, via sidelink control information two (SCI-2), an indication of whether coordinated CSI is to be performed.

The report component 810 may determine, based on stored configuration information, whether the CSI is to include one or more of a PMI and RI report, a CQI and RI report, or a PMI, CQI, and RI report. The transmission component 804 may transmit, prior to transmitting the selected PMI and RI pair as the CSI-related parameter, an indication of whether the first network node is to operate in the first mode or the second mode.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a second network node (e.g., UE 120, UE 504), or a second network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include a generation component 909 and/or a determination component 910, among other examples.

In some aspects, the apparatus 900 may be configured to perform one or more operations described herein in connection with FIGS. 1-5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the second network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the second network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the second network node described in connection with FIG. 2. In some aspects, the transmission component 904 may be co-located with the reception component 902 in a transceiver.

The reception component 902 may receive a first SL-RS from a first network node. The generation component 908 may generate CSI based on the first SL-RS. The transmission component 904 may transmit, to the first network node, the CSI and a second SL-RS. The reception component 902 may receive, from the first network node, a CSI-related parameter associated with the CSI or a communication based on the CSI-related parameter.

The transmission component 904 may transmit a request for coordinated CSI. The reception component 902 may receive, via SCI-2, an indication of whether coordinated CSI is to be performed. The determination component 910 may determine, based on stored configuration information, whether the CSI is to include one or more of a precoding matrix indicator PMI and RI report, a CQI and RI report, or a PMI, CQI, and RI report.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a first network node, comprising: transmitting a first sidelink reference signal (SL-RS) to a second network node; receiving, from the second network node, a second SL-RS and channel state information (CSI) that is associated with the first SL-RS; determining a CSI-related parameter based on the second SL-RS and the CSI; and transmitting, to the second network node, the CSI-related parameter or a communication based on the CSI-related parameter.

Aspect 2: The method of Aspect 1, wherein the CSI includes one or more precoding matrix indicators (PMIs), and wherein determining the CSI-related parameter includes determining a PMI from the one or more PMIs.

Aspect 3: The method of Aspect 2, wherein determining the PMI includes searching for a PMI that is spatially correlated with the one or more PMIs.

Aspect 4: The method of Aspect 2, wherein the first network node is incapable of performing a fast channel state feedback (CSF) procedure.

Aspect 5: The method of any of Aspects 1-4, wherein a transmit power of the first SL-RS is higher than a transmit power of the second SL-RS.

Aspect 6: The method of any of Aspects 1-4, wherein a transmit power of the first SL-RS is lower than a transmit power of the second SL-RS.

Aspect 7: The method of any of Aspects 1-6, wherein transmitting the first SL-RS and transmitting the CSI-related parameter includes transmitting the first SL-RS and transmitting the CSI-related parameter in connection with receiving a request for coordinated CSI.

Aspect 8: The method of any of Aspects 1-6, further comprising transmitting, via sidelink control information two (SCI-2), an indication of whether coordinated CSI is to be performed.

Aspect 9: The method of Aspect 8, wherein the indication indicates whether the CSI is to include one or more of a precoding matrix indicator (PMI) and rank indicator (RI) report, a channel quality indicator (CQI) and RI report, or a PMI, CQI, and RI report.

Aspect 10: The method of any of Aspects 1-9, further comprising determining, based on stored configuration information, whether the CSI is to include one or more of a precoding matrix indicator (PMI) and rank indicator (RI) report, a channel quality indicator (CQI) and RI report, or a PMI, CQI, and RI report.

Aspect 11: The method of any of Aspects 1-10, wherein receiving the CSI includes receiving the CSI in sidelink control information two (SCI-2) with SL-RS resource information.

Aspect 12: The method of any of Aspects 1-11, wherein the CSI includes one or more precoding matrix indicator (PMI) and rank indicator (RI) pairs, and wherein determining the CSI-related parameter includes: determining a PMI and RI pair only from among the one or more PMI and RI pairs, according to a first mode, or determining a PMI and RI pair that is not restricted to the one or more PMI and RI pairs, according to a second mode.

Aspect 13: The method of Aspect 12, further comprising transmitting, prior to transmitting the selected PMI and RI pair as the CSI-related parameter, an indication of whether the first network node is to operate in the first mode or the second mode.

Aspect 14: The method of any of Aspects 1-13, wherein transmitting the CSI-related parameter includes transmitting the CSI-related parameter with a third SL-RS.

Aspect 15: A method of wireless communication performed by a second network node, comprising: receiving a first sidelink reference signal (SL-RS) from a first network node; generating channel state information (CSI) based on the first SL-RS; transmitting, to the first network node, the CSI and a second SL-RS; and receiving, from the first network node, a CSI-related parameter associated with the CSI or a communication based on the CSI-related parameter.

Aspect 16: The method of Aspect 15, wherein the CSI includes one or more precoding matrix indicators (PMIs), and wherein the CSI-related parameter is one of the one or more PMIs.

Aspect 17: The method of Aspect 15 or 16, wherein the second network node is incapable of performing a fast channel state feedback (CSF) procedure.

Aspect 18: The method of any of Aspects 15-17, wherein a transmit power of the first SL-RS is higher than a transmit power of the second SL-RS.

Aspect 19: The method of any of Aspects 15-17, wherein a transmit power of the first SL-RS is lower than a transmit power of the second SL-RS.

Aspect 20: The method of any of Aspects 15-19, further comprising transmitting a request for coordinated CSI.

Aspect 21: The method of any of Aspects 15-20, further comprising receiving, via sidelink control information two (SCI-2), an indication of whether coordinated CSI is to be performed.

Aspect 22: The method of Aspect 21, wherein the indication indicates whether the CSI is to include one or more of a precoding matrix indicator (PMI) and rank indicator (RI) report, a channel quality indicator (CQI) and RI report, or a PMI, CQI, and RI report.

Aspect 23: The method of any of Aspects 15-22, further comprising determining, based on stored configuration information, whether the CSI is to include one or more of a precoding matrix indicator (PMI) and rank indicator (RI) report, a channel quality indicator (CQI) and RI report, or a PMI, CQI, and RI report.

Aspect 24: The method of any of Aspects 15-23, wherein transmitting the CSI includes transmitting the CSI in sidelink control information two (SCI-2) with SL-RS resource information.

Aspect 25: The method of any of Aspects 15-24, wherein the CSI includes one or more precoding matrix indicator (PMI) and rank indicator (RI) pairs, and wherein the method further includes transmitting, prior to transmitting the CSI, an indication of whether the first network node is restricted to determining a PMI and RI pair only from among the one or more PMI and RI pairs.

Aspect 26: The method of any of Aspects 15-25, wherein receiving the CSI-related parameter includes receiving the CSI-related parameter with a third SL-RS, and wherein the method further comprises verifying the CSI-related parameter based on the third SL-RS and transmitting a message or another CSI-related parameter to the first network node based on a result of the verifying.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first network node for wireless communication, comprising:
a memory; and
one or more processors coupled to the memory, wherein the one or more processors are configured to:
transmit a first sidelink reference signal (SL-RS) to a second network node;
receive, from the second network node, a second SL-RS and channel state information (CSI) that is associated with the first SL-RS;
determine a CSI-related parameter based on the second SL-RS and the CSI; and
transmit, to the second network node, the CSI-related parameter or a communication that is based on the CSI-related parameter.

2. The first network node of claim 1, wherein the CSI includes one or more precoding matrix indicators (PMIs), and wherein the one or more processors, to determine the CSI-related parameter, are configured to determine a PMI from the one or more PMIs.

3. The first network node of claim 2, wherein the one or more processors, to determine the PMI, are configured to search for a PMI that is spatially correlated with the one or more PMIs.

4. The first network node of claim 2, wherein the first network node is incapable of performing a fast channel state feedback (CSF) procedure.

5. The first network node of claim 1, wherein a transmit power of the first SL-RS is higher than a transmit power of the second SL-RS.

6. The first network node of claim 1, wherein a transmit power of the first SL-RS is lower than a transmit power of the second SL-RS.

7. The first network node of claim 1, wherein the one or more processors, to transmit the first SL-RS and transmit the CSI-related parameter, are configured to transmit the first SL-RS and transmit the CSI-related parameter in connection with receiving a request for coordinated CSI.

8. The first network node of claim 1, wherein the one or more processors are configured to transmit, via sidelink control information two (SCI-2), an indication of whether coordinated CSI is to be performed.

9. The first network node of claim 8, wherein the indication indicates whether the CSI is to include one or more of a precoding matrix indicator (PMI) and rank indicator (RI) report, a channel quality indicator (CQI) and RI report, or a PMI, CQI, and RI report.

10. The first network node of claim 1, wherein the one or more processors are configured to determine, based on stored configuration information, whether the CSI is to include one or more of a precoding matrix indicator (PMI) and rank indicator (RI) report, a channel quality indicator (CQI) and RI report, or a PMI, CQI, and RI report.

11. The first network node of claim 1, wherein the one or more processors, to receive the CSI, are configured to receive the CSI in sidelink control information two (SCI-2) with SL-RS resource information.

12. The first network node of claim 1, wherein the CSI includes one or more precoding matrix indicator (PMI) and rank indicator (RI) pairs, and wherein the one or more processors, to determine the CSI-related parameter, are configured to:
determine a PMI and RI pair only from among the one or more PMI and RI pairs, according to a first mode, or
determine a PMI and RI pair that is not restricted to the one or more PMI and RI pairs, according to a second mode.

13. The first network node of claim 12, wherein the one or more processors are configured to transmit, prior to transmitting the selected PMI and RI pair as the CSI-related parameter, an indication of whether the first network node is to operate in the first mode or the second mode.

14. The first network node of claim 1, wherein the one or more processors, to transmit the CSI-related parameter, are configured to transmit the CSI-related parameter with a third SL-RS.

15. A second network node for wireless communication, comprising:
a memory; and
one or more processors, coupled to the memory, wherein the one or more processors are configured to:
receive a first sidelink reference signal (SL-RS) from a first network node;
generate channel state information (CSI) based on the first SL-RS;
transmit, to the first network node, the CSI and a second SL-RS; and
receive, from the first network node, a CSI-related parameter associated with the CSI or a communication that is based on the CSI-related parameter.

16. The second network node of claim 15, wherein the CSI includes one or more precoding matrix indicators (PMIs), and wherein the CSI-related parameter is one of the one or more PMIs.

17. The second network node of claim 15, wherein the second network node is incapable of performing a fast channel state feedback (CSF) procedure.

18. The second network node of claim 15, wherein a transmit power of the first SL-RS is higher than a transmit power of the second SL-RS.

19. The second network node of claim 15, wherein a transmit power of the first SL-RS is lower than a transmit power of the second SL-RS.

20. The second network node of claim 15, wherein the one or more processors are configured to transmit a request for coordinated CSI.

21. The second network node of claim 15, wherein the one or more processors are configured to receive, via sidelink control information two (SCI-2), an indication of whether coordinated CSI is to be performed.

22. The second network node of claim 21, wherein the indication indicates whether the CSI is to include one or more of a precoding matrix indicator (PMI) and rank indicator (RI) report, a channel quality indicator (CQI) and RI report, or a PMI, CQI, and RI report.

23. The second network node of claim 15, wherein the one or more processors are configured to determine, based on stored configuration information, whether the CSI is to include one or more of a precoding matrix indicator (PMI) and rank indicator (RI) report, a channel quality indicator (CQI) and RI report, or a PMI, CQI, and RI report.

24. The second network node of claim 15, wherein the one or more processors, to transmit the CSI, are configured to transmit the CSI in sidelink control information two (SCI-2) with SL-RS resource information.

25. The second network node of claim 15, wherein the CSI includes one or more precoding matrix indicator (PMI) and rank indicator (RI) pairs, and wherein the one or more processors are configured to transmit, prior to transmitting the CSI, an indication of whether the first network node is restricted to determining a PMI and RI pair only from among the one or more PMI and RI pairs.

26. The second network node of claim 15, wherein the one or more processors, to receive the CSI-related parameter, are configured to receive the CSI-related parameter with a third SL-RS, and wherein the one or more processors are configured to verify the CSI-related parameter based on the third SL-RS and transmit a message or another CSI-related parameter to the first network node based on a result of the verifying.

27. A method of wireless communication performed by a first network node, comprising:
transmitting a first sidelink reference signal (SL-RS) to a second network node;
receiving, from the second network node, a second SL-RS and channel state information (CSI) that is associated with the first SL-RS;
determining a CSI-related parameter based on the second SL-RS and the CSI; and
transmitting, to the second network node, the CSI-related parameter or a communication that is based on the CSI-related parameter.

28. The method of claim 27, wherein the CSI includes one or more precoding matrix indicators (PMIs), and wherein determining the CSI-related parameter includes determining a PMI from the one or more PMIs.

29. A method of wireless communication performed by a second network node, comprising:
receiving a first sidelink reference signal (SL-RS) from a first network node;
generating channel state information (CSI) based on the first SL-RS;
transmitting, to the first network node, the CSI and a second SL-RS; and
receiving, from the first network node, a CSI-related parameter associated with the CSI or a communication that is based on the CSI-related parameter.

30. The method of claim 29, further comprising transmitting a request for coordinated CSI.
